(19) United States
(12) Patent Application Publication
(10) Pub. No.: US 2006/0165972 A1
(43) Pub. Date: Jul. 27, 2006

(54) Lightweight, high-strength load bearing floor structure

(76) Inventors: Robert R. Chimelak, Warren, MI (US); Steven D. McClintock, South Lyon, MI (US); John J. Reynolds, Howell, MI (US)

Correspondence Address: HONIGMAN MILLER SCHWARTZ & COHN LLP, 38500 WOODWARD AVENUE, SUITE 100, BLOOMFIELD HILLS, MI, 48304-5048, US

(21) Appl. No.: 11/242,697

(22) Filed: Oct. 4, 2005

Related U.S. Application Data
(60) Provisional application No. 60/647,547, filed on Jan. 27, 2005.

(51) Int. Cl. B32B 3/26

(52) U.S. Cl. 428/319.1; 428/319.3; 428/319.7

(57) ABSTRACT

A lightweight, high-strength load bearing floor structure includes a core made of expanded polyolefin foam material and a layer of material bonded or otherwise attached to an upper surface and a lower surface of the core to sandwich the core. The layer of material is made of a lightweight, high-strength material, such as a metallic material, or the like. An upper panel and lower panel may be mounted to the metallic layers, and a decorative covering may be applied to one of the upper and lower panels. The core and layers of material form a high modulus, high stiffness, lightweight composite structure suitable for load bearing floor applications, or the like.

### CLAIM TO PRIORITY

This application claims the benefit of U.S. Provisional Application No. 60/647,547, filed Jan. 27, 2005, the entire contents of which are herein incorporated by reference.

### BACKGROUND OF THE INVENTION

1. Field of the Invention

The invention relates in general to high modulus, high stiffness composite structure suitable for use in the transportation industries as load bearing floor structures, seatbacks, or the like, and in particular to a composite structure comprising a semi-flexible or rigid, but non-friable, polymer foam core or substrate having appreciable areal dimensions, which is sandwiched by a lightweight, high-strength metallic material, such as aluminum and the like.

2. Description of the Related Art

In many industries, particularly in the aircraft and transportation industries, there is considerable impetus for the reduction of weight of vehicle components. In many cases, for example, these reductions in weight are necessary to achieve designated fuel economy standards which are becoming ever more stringent. Thus, it has become common within the automotive sector as well as in other transportation industries, to consider alternative designs of many vehicle components, even when the alternative designs incur a cost penalty, if the resulting parts can achieve significant weight savings.

There are many parts for which weight savings are desired. For example, in the automotive industry load floors and seatbacks are but two of such items. Load floors are essentially planar structures of fairly large areal dimensions that are placed over cargo holds, spare tire recesses, and the like. Because these floors must not overly flex upon the addition of a cargo load to the vehicle, or by the presence of vehicle occupants over this area, these floors must have appreciable stiffness. However, current floors, in order to achieve this required stiffness, are made of relatively thick section, dense materials which do not lend themselves to weight savings. Likewise, in the case of seatbacks, the relatively large buckets that surround many seats would desirably be produced in lighter weight versions without losing their structural capabilities. In the non-automotive industries, articles such as molded seats, garage doors, and the like are also amenable to use of lightweight, yet strong and highly stiff materials.

In the past, when high stiffness, high modulus materials have been utilized, they have often been prepared from substrates, such as aluminum or thermoplastic honeycomb materials onto which aluminum or fiber-reinforced thermosetting skins are applied. These materials have particularly high stiffness and modulus, but their cost is prohibitive due to the very high cost of honeycomb materials. Moreover, such materials do not lend themselves to the attachment of fasteners, hinges, and other hardware items; nor are they easily formable to other than strictly planar shapes.

Glass mat reinforced thermoplastic materials (GMT) have been in use for several years. These materials are manufactured by laying down numerous strands of glass fibers into a planar array, and needling these fibers with a needle board containing numerous barbed needles. The needling operation causes the fibers to intertwine, to break, and to assume a more random distribution. The mats thus produced have the appearance of a deep pile velvet material having a thickness of from about 3 or 10 mm. These needled glass fiber mats are then impregnated with a thermoplastic in a continuous double band press. The impregnation is done at such a pressure that a lofty (low density and unconsolidated) material is produced. This lofty GMT “intermediate” product may then be laid up into a shape suitable for thermoforming. The layup may contain from one to ten or more layers of GMT material. The GMT material is generally heated prior to placement into a mold, although heated molds may be occasionally used. The material is then fully densified under high pressure to form a very stiff, high modulus, fiber reinforced product. Because of the relatively long and complicated processes, production time is relatively long and therefore expensive.

Thus, there is a need to a load floor structure that is thin, lightweight, cost-effective and sufficiently strong to withstand the load requirements for automotive applications.

### SUMMARY OF THE INVENTION

The inventors have recognized these and other problems associated with conventional composite structures suitable for use as load bearing floor structures and have developed a composite structure that is thin, lightweight, cost-effective and sufficiently strong to withstand the load requirements for automotive applications.

According to the invention, a load bearing floor structure comprises a foam core made of an expanded polyolefin material, the foam core having an upper surface and a lower surface; a first layer of lightweight, high-strength material bonded to the upper surface of the foam core; and a second layer of lightweight, high-strength material bonded to the lower surface of the foam core, wherein said foam core, said first layer and said second layer form a high modulus, high stiffness, lightweight composite structure.

### BRIEF DESCRIPTION OF THE DRAWINGS

In the drawings:

FIG. 1 is an exploded perspective view of the load bearing floor structure according to an embodiment of the invention.

FIG. 2 is an exploded cross sectional view of a composite structure of the load bearing floor structure taken along line 2-2 of FIG. 1 according to an embodiment of the invention.

### DESCRIPTION OF THE PREFERRED EMBODIMENT

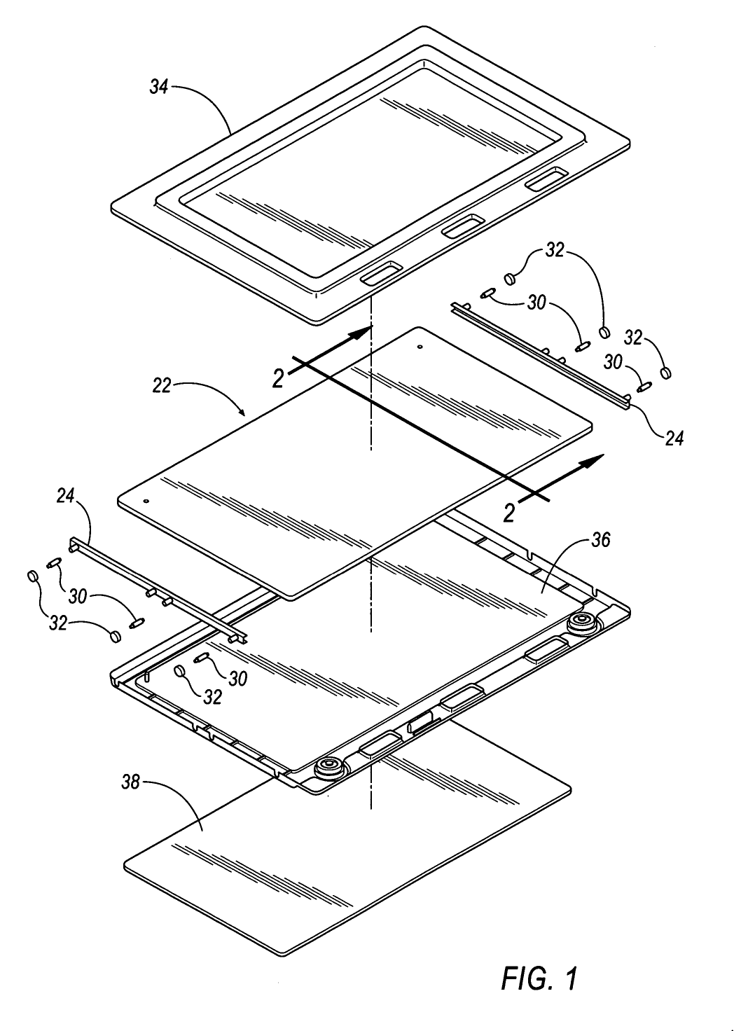

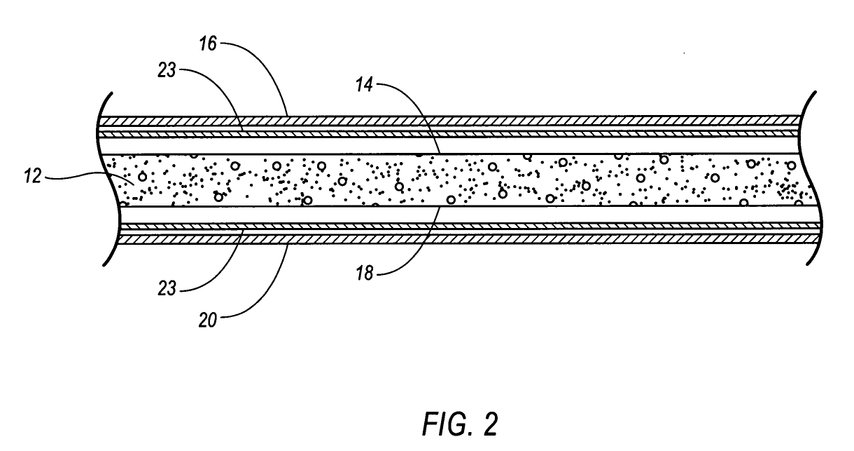

Referring now to FIGS. 1 and 2, a load bearing floor structure 10 is generally shown according to an embodiment of the invention. The load bearing floor structure 10 includes a foam core or substrate 12 having a top surface 14 covered by a metallic layer or skin 16, and a bottom surface 18 similarly covered by a bottom metallic layer or skin 20. The foam core 12, along with the metallic layers 16, 20, form a composite structure 22 for the load bearing floor structure 10.

The foam core 12 is preferably made of expanded polyolefin (EPO), more particularly expanded polypropylene (EPP) or expanded polystyrene (EPS) with a 2-lb density and having a thickness of approximately 0.625″ (15.875 mm). Expanded polyolefin is generally supplied in the form of expandable beads which are then placed into a suitable mold and heated by hot air or steam, whereby they expand and the cell walls fuse. The resulting products have a high degree of strength as well as a high capacity for energy absorption. The foams may be molded in flat sheets; large blocks which are then sliced, if necessary, to form sheet material or material of other shapes; or the beads may be molded into a substantially net shape product of complex form. The preparation and use of expandable polyolefins is disclosed in U.S. Pat. Nos. 4,676,939; 4,769,393; 5,071,883; 5,459,169; 5,468,781; and 5,496,864, which are herein incorporated by reference.

While the foam core 12 is preferably made of EPO material, the invention is not limited thereto. Other foams are highly suitable for use in the subject invention, provided they are sufficiently strong to resist the compression loading which occurs during the molding operation, and may be fused to the polymer impregnant of the GMT skin. Examples of suitable foam are extruded and bead-type polystyrene foam, polyvinylchloride foam, and polyurethane foam. In the case of polyurethane foam, the polyurethane foam should be a semi-flexible foam or rigid foam which is non-friable. Such foams are produced, as is well known to those skilled in the art, from polyol components having substantial quantities of di- and trifunctional polyols as opposed to rigid insulation foams which are prepared from essentially all higher-functional polyols, and which generally employ excess isocyanate in conjunction with trimerization catalysts to form isocyanurate linkages. The polyurethane foams will in general be softenable by heat, i.e. such that they may sufficiently bond to the polypropylene or other GMT matrix polymer. Reference may be had to POLYURETHANES: CHEMISTRY AND TECHNOLOGY, Saunders and Frisch, John Wiley & Sons, N.Y.

Syntactic foams may also be used. Such foams are prepared by admixing polymeric or inorganic microballoons with a suitable polymer matrix resin and hardening into shape. These syntactic foams may be supplied in sheet form, block, or in net shaped products. Examples of microballoons which are commonly used are phenolic microballoons and glass microballoons. Such products are well known to those skilled in the art, and due to their polymer matrix, are still considered “polymer foams” as that term is used herein.

The metallic layers 16, 20 that lies above and below the foam core 12 may consist of one or more layers of lightweight, high-strength metallic material, for example, epoxy primed aluminum commonly known as A1-3105 H-14 having a thickness of approximately 0.032″ (0.813 mm). However, the thickness, and thus also the number of metallic layers 16, 20 in the composite structure 22 of the invention may be tailored for a particular application. Thus, it is quite conceivable that one or more layers of metallic material up to 3 to 4 cm in thickness, more commonly 1 to 2 cm in thickness may be necessary in certain portions of designs where high structural loads are expected in these areas. This is true for example in seatback products, where the more or less planar back, i.e. a back having substantial areal dimensions, is not expected to encounter large forces along this areal dimension, but other points must accept high loads. Thus, the metallic layers 16, 20 above and below the portion of the foam core substrate 12 having appreciable areal dimensions may be made relatively thin. However, other portions of the seatback, i.e. the side frame, or points where hardware may be attached, should be relatively thick. In other instances, for example, load floors or the like, only one metallic skin layer may be quite suitable in the surround.

It will be appreciated that the invention can be practiced by the use of other suitable lightweight materials for the layers 16, 20. For example, the invention can be practiced by the use of a thermoplastic or a thermosetting fiber reinforced skins, rather than the use of metallic material for the layers 16, 20.

Each layer 16, 20 is bonded to the foam core 12 by an application of a commercially available and known urethane adhesive 23, such as 3030D urethane adhesive, or the like. Although adhesives are generally preferred to be avoided, it would not depart from the spirit of the invention to include a rapidly curing thermoset adhesive or a thermoplastic adhesive, for example a film adhesive. In this case, in particular, commercial film adhesives or hot melt adhesives may be applied between the foam core 12 and the metallic layers 16, 20.

As mentioned earlier, the high modulus, high stiffness composite structure 22 is suitable for use in the transportation industries as a load bearing floor structure 10. Accordingly, the load bearing floor structure 10 of the invention is designed to meet certain design criteria. Specifically, the load bearing floor structure 10 is designed to carry a load of 200-lb (91-kg) that is evenly distributed on the top of the load floor at 23° C., 70° C. and −30° C. for seven (7) days at each temperature without functional damage or cracking. In addition, the load bearing floor structure 10 is designed to withstand loads of 50-lb (23-kg) dropped from a distance of 800 mm above the load floor at 23° C., 70° C. and −30° C. without any functional damage or cracking. Further, the load bearing floor structure 10 is designed to withstand a 150-lb (68.2-kg) knee form load at 23° C., 70° C. and −30° C. without any functional damage or cracking, and a maximum deflection set of 6 mm.

The load bearing floor structure 10 may include a channel 24 attached to each longitudinal side 26, 28 of the composite structure 22. Each channel 24 is preferably C-shaped in cross section so that each channel 24 can be fitted each longitudinal side 26, 28. Each channel 24 may include a shaft 30 and a wheel 32 rotatably mounted to the end of the shaft 30 to enable the load bearing floor structure 10 to movably slide within a pair of track or guide members (not shown).

The load bearing floor structure 10 may further include an upper panel 34 made of extruded plastic material mounted to the layer 16, and a similarly configured lower panel 36 mounted to the layer 20. The upper and lower panels 34, 36 provide additional durability and an aesthetic appearance to the load bearing floor structure 10. The upper and lower panels 34, 36 can be mounted to the layers 16, 20 by use of any suitable fastening means, such as a threaded fastener, or the like.

In addition, a decorative covering 38 may be mounted to one or both of the upper and lower panels 34, 38 to provide a more decorative appearance and softer feel to the load bearing floor structure 10. The covering 38 may comprise a carpet, or the like, that can be mounted to one or both of the upper and lower panels 34, 38 by use of any suitable means, such as a commercially available adhesive, or the like.

It will be appreciated that the load bearing floor structure 10 can also include additional features, such as a handle, a pivot, or the like, suitable for use in conventional load bearing floor structures. Such additional features are omitted herein for brevity.

As described above, the invention provides a high modulus, high stiffness composite structure suitable for use in the transportation industries as load bearing floor structures, seatbacks, or the like.

While the invention has been specifically described in connection with certain specific embodiments thereof, it is to be understood that this is by way of illustration and not of limitation, and the scope of the appended claims should be construed as broadly as the prior art will permit.

What is claimed is:

1. A load bearing floor structure, comprising:
a composite structure comprising:
a core made of an expanded polyolefin foam material having first and second exterior surfaces,
a first layer made of metallic material bonded to the first exterior surface the core, and
a second layer made of metallic material bonded to the second exterior surface of the core;
a first panel mounted to the composite structure; and
a second panel made of metallic material mounted to the composite structure.

2. The load bearing floor structure of claim 1, further comprising a decorative covering mounted to one of the first and second panels.

3. The load bearing floor structure of claim 1, wherein the core of said composite structure is made of an expanded polystyrene material.

4. The load bearing floor structure of claim 3, wherein the core of said composite structure has a thickness of approximately 0.625 inches.

5. The load bearing floor structure of claim 1, wherein the first and second layers of said composite structure are made of aluminum.

6. The load bearing floor structure of claim 5, wherein the first and second layers of said composite structure have a thickness of approximately 0.032 inches.

7. The load bearing floor structure of claim 1, wherein the first panel is made of plastic material.

8. The load bearing floor structure of claim 1, wherein the second panel is made of plastic material.

9. A composite structure for a load bearing floor structure, comprising:
a core made of an expanded polyolefin foam material having first and second exterior surfaces,
a first layer made of metallic material bonded to the first exterior surface the core, and
a second layer made of metallic material bonded to the second exterior surface of the core,
wherein said core, said first layer and said second layer form a composite structure for a load bearing floor structure.

10. The composite structure of claim 9, wherein the core of said composite structure is made of an expanded polystyrene material.

11. The composite structure of claim 10, wherein the core of said composite structure has a thickness of approximately 0.625 inches.

12. The composite structure of claim 9, wherein the first and second layers of said composite structure are made of aluminum.

13. The composite structure of claim 12, wherein the first and second layers of said composite structure have a thickness of approximately 0.032 inches.
